(19) United States
(12) Patent Application Publication
(10) Pub. No.: US 2007/0170025 A1
(43) Pub. Date: Jul. 26, 2007

(54) Dual cylinder shock and method therefor

(75) Inventor: Jerry Presley, Prescott Valley, AZ (US)

Correspondence Address: WEISS & MOY PC, 4204 NORTH BROWN AVENUE, SCOTTSDALE, AZ, 85251, US

(73) Assignee: PERFORMANCE AUTOMOTIVE GROUP, INC.

(21) Appl. No.: 11/339,146

(22) Filed: Jan. 25, 2006

(51) Int. Cl. F16F 9/00

(52) U.S. Cl. 188/314

(57) ABSTRACT

A method for forming a reservoir shock absorber uses an after market twin-tube/double chamber shock absorber. An opening is formed by friction drilling the outer surface of the dual chamber shock absorber. The opening is formed into an outer chamber of the dual chamber shock. The opening is then tapped to form a plurality of threads.

### FIELD OF THE INVENTION

The present invention relates generally to a shock absorber and, more specifically, to a twin-tube/dual cylinder shock and a method of attaching a reservoir to a twin-tube/dual cylinder shock using a friction drilling process.

### BACKGROUND OF THE INVENTION

A shock absorber is placed between the frame of the vehicle and the wheels to absorb mechanical shocks in order to dampen the jarring sustained when driving a motor vehicle. One type of shock is a twin-tube/double-cylinder shock absorber. A twin-tube/double cylinder shock absorber includes an inner cylinder filled with oil. A piston and rod extends into the inner cylinder through the upper end of the inner cylinder and divides the cylinder into upper and lower oil chambers. An outer cylinder is coaxially disposed around the inner cylinder and forms therewith an annular reservoir chamber having closed upper and lower ends. The lower portion of the reservoir chamber is filled with oil and the upper portion is filled with gas. A passage way is provided between the upper portion of the reservoir chamber and the inner cylinder. In operation, excess oil from the upper oil chamber of the inner cylinder will pass into the reservoir chamber but gas in the reservoir chamber closes the gas seal thereby to seal the passage.

During upward movement fluid will be displaced from the upper oil chamber into the lower oil chamber. The lower oil chamber does not have a piston rod in it and the fluid displaced from the upper oil chamber will not be sufficient to make up the volume of displaced fluid. For this reason, it is the practice to employ a reservoir chamber, which is coupled to the lower chamber through a conduit.

Presently, there is no way to add an auxiliary reservoir chamber to a twin-tube/double cylinder shock. Thus, one cannot convert a twin-tube/double cylinder shock to a reservoir shock. Individuals have tried to drill openings in the twin-tube/double cylinder shock to add a reservoir chamber. However, the drilling of the opening contaminates the twin-tube/double cylinder shock with metal filings.

Therefore, a need existed to provide a system and method to overcome the above problem.

### SUMMARY OF THE INVENTION

A method for forming a reservoir shock absorber is disclosed. The method uses an after market twin-tube/double cylinder shock absorber. An opening is formed by friction drilling the twin-tube/double cylinder shock absorber. The opening is formed into an outer chamber of the twin-tube/double cylinder shock. The opening is then tapped to form a plurality of threads.

The present invention is best understood by reference to the following detailed description when read in conjunction with the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a cross-sectional view of one embodiment of the reservoir shock absorber;

FIG. 2 is a magnified view of the connection to the reservoir chamber of the reservoir shock absorber depicted in FIG. 1;

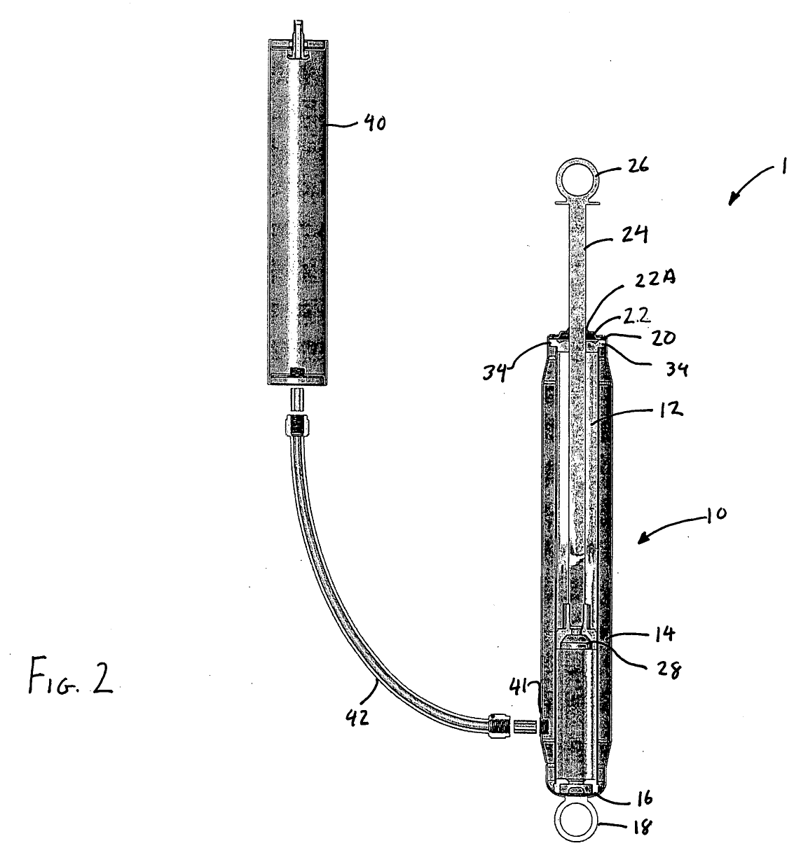

FIG. 3 is a cross-sectional view of another embodiment of the reservoir shock absorber; and

FIG. 4 is a flow chart depicting a method of forming a reservoir shock absorber.

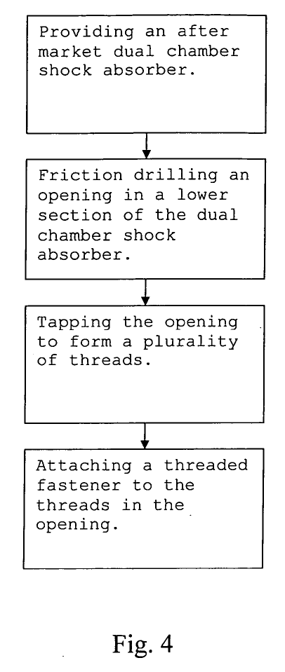

Common reference numerals are used throughout the drawings and detailed descriptions to indicate like elements.

### DESCRIPTION OF THE PREFERRED EMBODIMENT

Referring now to the Figures, a system and method for forming a reservoir shock absorber 1 will be disclosed. The system and method will allow one to convert a twin-tube/double cylinder shock absorber 10 into a reservoir shock absorber 1. The reservoir shock absorber 1 uses a standard twin-tube/double cylinder shock 10. The twin-tube/double cylinder shock 10 has a cylindrical inner chamber 12. The inner chamber 12 is coaxially surrounded by an outer chamber 14. The outer chamber 14 is closed by a lower cap 16 which is coupled to a mounting ring 18. The lower cap 16 also closes the lower end of inner chamber 12. The upper end of the outer chamber 14 is partially closed by a cap 20. The upper end of the inner chamber 12 is partially closed by a rod guide 22. The rod guide 22 will have a centrally located opening 22A. The central opening 22A of rod guide 22 accepts a piston rod 24. The piston rod 24 will have a mounting ring 26 on one end and a piston 28 at the other end. The inner chamber 12 is generally filled with oil. The outer chamber 12 is generally divided into a lower section 30 and an upper section 32. The lower section 32 is generally filled with oil. The upper section 32 is generally filled with gas such as nitrogen.

A small gap is present between the rod guide 22 and the piston rod 24. The gap is coupled to the outer chamber 14 via a channel 34. A seal assembly 36 is disposed in the channel 34. The seal assembly engages the cylindrical surface of piston rod 24 to prevent the escape of oil and gas from shock absorber 10. The seal assembly has a flap which engages an outer surface of the rod guide 22. The flap is deflected by oil passing through the gap between the rod guide 22 and the piston rod 24 allowing the oil to pass into the outer chamber 14. However, gas in the outer chamber 14 will force the flap against the outer surface of the rod guide 22 to prevent the gas from entering into the oil or inner chamber 12.

In order to provide a greater degree of damping and cooling of the twin-tube/double cylinder shock absorber 10, a reservoir chamber 40 is coupled to the outer chamber 14 via a conduit 42. When the piston rod 24 moves downwardly, fluid will be displaced from the outer chamber 14 into the reservoir chamber 40. The reservoir chamber 40 has an internal volume that is partially filled with oil and pressurized by means of a high pressure gas. Normally, nitrogen gas is provided for this purpose.

In the prior art, there was not a way to add a reservoir chamber 40 to an after market twin-tube/double cylinder shock 10. However, by friction drilling the outer chamber 14, one can add a reservoir chamber 40 to an after market twin-tube/double cylinder shock 10 to form a reservoir shock absorber 1 of the present invention.

Friction drilling is a process for efficiently making bush-shaped holes in thin-walled metals. The holes are used as tap holes for high-strength threads made by the drilling process. In accordance with one embodiment of the present invention, a Flowdrill is used for friction drilling a hole 41 in the outer surface 44 of the twin-tube/double cylinder shock 10. The Flowdrill comes into contact with the outer surface 44 of the twin-tube/double cylinder shock 10 using a relatively high axial pressure and rotational speed. The heat generated by the high axial pressure and rotational speed of the Flowdrill makes the metal of the outer surface 44 of the twin-tube/double cylinder shock 10 soft and malleable enough to be formed and perforated. As the Flowdrill pushes into the metal of the outer surface 44 of the double-cylinder shock 10, some of the displaced metal forms a collar 43 around the outer surface 44. The rest of the metal forms a bushing 46 in the interior wall 48 of the outer chamber 14. Thus, the friction drilling process will not contaminate the double-cylinder shock 10 with metal filings. The resulting collar 43 and bushing 46 can be up to 3 times the original material thickness. The friction drilling process does not disturb the internal structure of the twin-tube/double cylinder shock 10. As a result; the formed bushing 46 is remarkably strong.

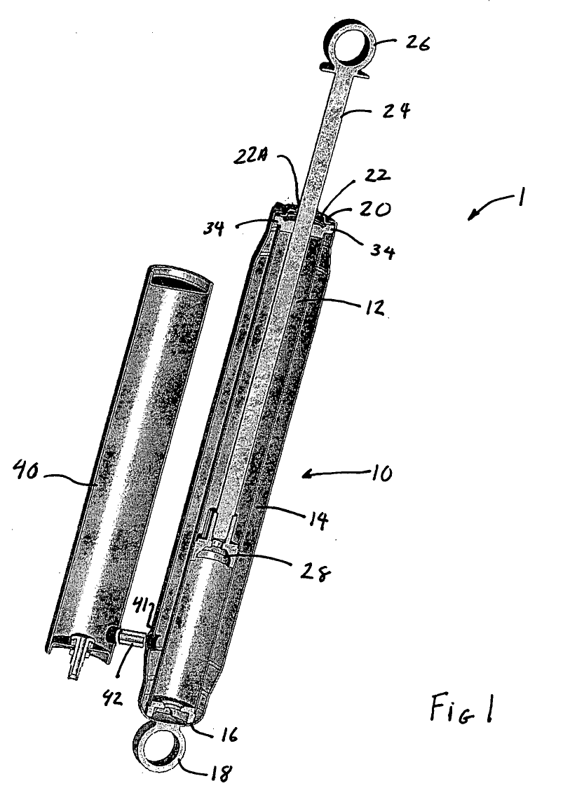

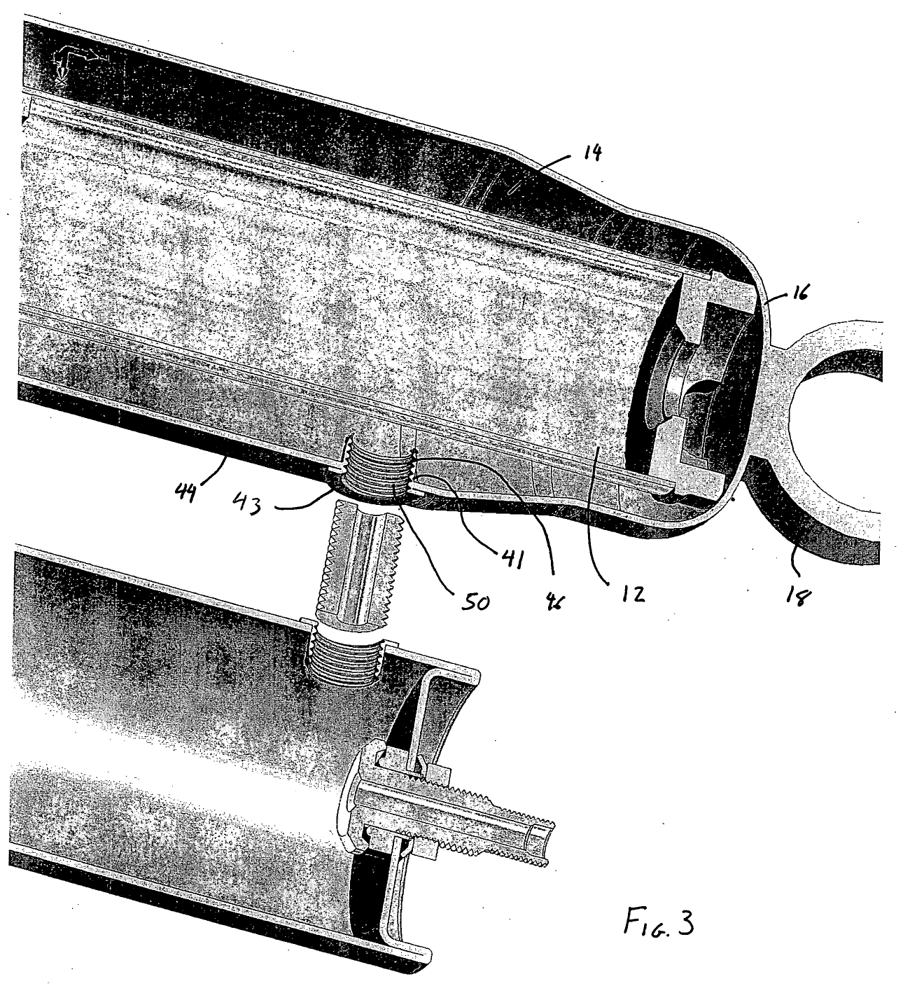

After the hole 41 is formed through the outer. surface of the twin-tube/double cylinder shock 10 and into the outer chamber 14, the hole is tapped to form a plurality of threads 50. In accordance with one embodiment of the present invention, the hole 41 is tapped using a Flowtap. The Flowtap process is similar to Flowdrilling except a tap is used to form threads 50 in the hole 41. The threads 50 produce are superior in strength as compared to conventional threads. The formed threads 50 avoid cutting the natural grain of the metal. The compressed structure provides higher pull-out strength and torque specifications. The threaded hole 41 can accommodate either a threaded fastener (FIG. 1) or a stainless steel braided hydraulic line (FIG. 3) as the conduit 42. Once the after market twin-tube/double cylinder shock 10 is coupled to the reservoir chamber 40, the reservoir chamber 40 is filled with oil and compressed with nitrogen. The oil and nitrogen are added through a valve 52.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A method for forming a reservoir shock absorber comprising:
providing an after market twin-tube/double chamber shock absorber;
friction drilling an opening in a section of the dual chamber shock absorber into an outer chamber of the dual chamber shock; and
tapping the opening to form a plurality of threads.

2. The method of claim 1 further comprising:
attaching a threaded fastener to the threads in the opening; and
coupling a reservoir chamber to the threaded fastener.

3. The method of claim 2 further comprising:
filling the reservoir chamber partially with oil: and
filling the reservoir chamber with nitrogen.

4. The method of claim 1 further comprising:
attaching a threaded fastener to the threads in the opening; and
coupling a hydraulic line to the threaded fastener and to the reservoir chamber.

5. The method of claim 4 further comprising.:
filling the reservoir chamber partially with oil: and
filling the reservoir chamber with nitrogen.

6. The method of claim 1 wherein friction drilling an opening further comprises flowdrilling the opening in the outer surface of a twin-tube/double chamber shock absorber.

7. The method of claim 1 wherein tapping the opening further comprises flow tapping the opening to form the plurality of threads.

8. A method for forming a reservoir shock absorber comprising:
providing an after market twin-tube/double chamber shock absorber;
friction drilling an opening in a lower section of the dual chamber shock absorber into an outer chamber of the dual chamber shock;
tapping the opening to form a plurality of threads;
attaching a threaded fastener to the threads in the opening; and
coupling a reservoir chamber to the threaded fastener.

9. The method of claim 8 further comprising:
filling the reservoir chamber partially with oil: and
filling the reservoir chamber with nitrogen.

10. The method of claim 8 further comprising coupling a hydraulic line to the threaded fastener and to the reservoir chamber.

11. The method of claim 10 further comprising:
filling the reservoir chamber partially with oil: and
filling the reservoir chamber with nitrogen.

12. A reservoir shock absorber comprising:
an after market twin-tube/double chamber shock absorber;
an opening in the outer surface of the twin-tube/double chamber shock absorber formed by friction drilling the hole into an outer chamber of the twin-tube/double chamber shock; and
a plurality of threads formed in the opening by tapping the opening.

13. A reservoir shock absorber in accordance with claim 12 further comprising a threaded fastener coupled to the threads in the opening for coupling the reservoir chamber to the dual chamber shock absorber.

14. A reservoir shock absorber in accordance with claim 12 wherein the opening formed by friction drilling further comprises flowdrilling the opening in the outer section of the twin-tube/double chamber shock absorber.

15. A reservoir shock absorber in accordance with claim 12 wherein the threads formed in the opening by tapping the opening further comprises flow tapping the opening to form the plurality of threads.
